(19) United States
(12) Patent Application Publication
(10) Pub. No.: US 2022/0173675 A1
(43) Pub. Date: Jun. 2, 2022

(54) METHOD FOR THE VIBRATION-REDUCED OPERATION OF A BLDC MOTOR

(71) Applicant: NIDEC DRIVEXPERT GMBH, Ilmenau (DE)

(72) Inventors: Sandro Purfuerst, Ilmenau (DE); Robert Reichert, Ilmenau (DE)

(21) Appl. No.: 17/436,792

(22) PCT Filed: Feb. 27, 2020
(86) PCT No.: PCT/DE2020/000040

§ 371 Date: Sep. 7, 2021

(30) Foreign Application Priority Data
Mar. 4, 2019 (DE) 10 2019 001 463.4

(51) Int. Cl. H02P 6/10

(52) U.S. Cl. CPC H02P 6/10; H02P 2207/05

(57) ABSTRACT

A method for the optimized operation of a BLDC motor with a BLDC motor assembly that includes the BLDC motor;—a control and evaluation unit;—a data memory;—a current regulator;—a rotor angle sensor; and—a torque evaluator. The BLDC motor includes a stator and a rotor. The rotor includes excitation magnets, and the stator has stator coils. A current is applied to the stator coils. The size of the current is defined in a value table depending on the rotor angle. The current values in the value table are continually optimized in accordance with a deviation between a setpoint torque and a determined actual torque.

The invention relates to a method for the vibration-reduced operation of a brushless direct current motor, hereinafter referred to as a BLDC motor or brushless direct current motor.

BLDC motors are known as such from the state of the art. BLDC motors have a fixed stator with stator coils and a movable rotor, which usually comprises permanent-magnetic material. The stator coils are actuated by an electronic circuit with time delay and thus form a magnetic rotating field which interacts with the rotor and causes the rotation of the rotor.

Furthermore, control methods are known which are related to the commutation of the phase current applied to the coils in order to enable the motor to run as reliably and smoothly as possible. With regard to commutation, a distinction is made between sensor-controlled and sensorless commutation. In the case of sensor-controlled commutation, a sensor detects a rotor position and the commutation is controlled on the basis of this detection.

For example, DE 197 43 314 A1 describes a BLDC motor with a permanent-magnetic rotor and a control circuit which detects the position of the rotor and, depending on the detected rotor position, controls the application of current to the stator coils.

DE 103 08 859 A1 describes a method for operating a BLDC motor in which commutation times are determined on the basis of the detection of the time interval between zero crossings of the induced voltage in the respective motor coil to which current is not applied.

The disadvantage of these solutions is that smooth running and vibration behaviour are only optimized to a limited extent

The task of the invention is to provide a solution for a method of operating a BLDC motor, which enables low-vibration and smooth motor running, can be applied with little effort to different designs and sizes of BLDC motors, and effectively reduces the noise emissions.

The task is solved by the features specified in Claim 1. Preferred further embodiments result from the subclaims.

The method according to the invention for the vibration-reduced operation of a switched BLDC motor is performed by means of a BLDC motor assembly which has the features described below.

The BLDC motor assembly comprises, on the one hand, the BLDC motor. Furthermore, the BLDC motor assembly includes a control and evaluation unit, a data memory, a current regulator, a rotor angle sensor and a torque evaluator.

The data memory, the current regulator, the rotor angle sensor and the torque evaluator are each connected to the control and evaluation unit.

The rotor angle sensor is designed to determine the angular position of the rotor, preferably by detecting the rotor magnetic field. This can also be done by measuring the voltage or current in a non-switched stator coil so that the rotor angle sensor does not necessarily have to be designed as an independent structural component.

The control and evaluation unit is designed to receive data from the rotor angle sensor and torque evaluator and to process them. Furthermore, the control and evaluation unit is configured to control the current regulator and to read data from and also to write data in the data memory. The control and evaluation unit is preferably an electronic circuit such as a computer or a controller. In particular, the data memory, the torque evaluator and the current regulator can form an integrated structural unit together with the control and evaluation unit.

According to the invention, the BLDC motor comprises a stator with stator coils and a rotor. The rotor is preferably located inside a rotational-symmetric stator and is pivoted around a rotation axis.

The stator comprises soft magnetic material in a tooth structure. The teeth are hereinafter also referred to as stator teeth. The stator coils are assigned to the stator teeth and a current can be applied to them.

The rotor is preferably permanent-magnetic. In this case, permanent magnets are preferably arranged in a rotational-symmetric manner around the rotation axis. The permanent magnets can be arranged in different variants. In one arrangement variant, the rotor is designed as a cylinder in which the permanent magnetic poles are arranged alternately in circular sectors. Circular north pole and south pole sectors alternate.

In another variant, the rotor has a tooth structure with permanent magnetic teeth with alternating magnetic polarity.

Hereinafter, the teeth of the tooth structure of the rotor are also referred to as rotor teeth or rotor arms.

The BLDC motor is designed such that a magnetic field of the stator, also referred to as a stator magnetic field or stator field, is generated by applying an electric current to the stator coils. Due to the interaction of the stator field with the magnetic field, a torque acts on the rotor. Thus, the geometric arrangement of the rotor teeth and stator teeth relative to each other causes the rotor to rotate. By switching the stator coils on and off at different stator teeth, the position of the magnetic field of the stator is changed so that the rotor repeatedly realigns by rotation in accordance with the acting torque. In the following, the BLDC motor is also referred to, in a shortened form, as the motor.

The method according to the invention is based on the finding that the rotor teeth and the stator teeth deform as a result of the force caused by the interaction of the rotor magnetic field and the stator magnetic field, in particular transversely to their longitudinal axes. This deformation is not constant due to the changeability of the interaction of the rotor magnetic field and the stator magnetic field and leads to vibrations of the rotor teeth and the stator teeth as well as, in some cases, of other mechanically connected components of the BLDC motor or a driven unit. These vibrations cause adverse dynamic loads and are also perceived as noise in an audible frequency range. To reduce such vibrations and consequently the noise, the method provides a solution according to which the force on the rotor teeth and stator teeth is controlled in such a way that their vibration is reduced. For this purpose, the torque is kept as constant as possible in all angular positions of the rotor. Consequently, substantially constant forces also act on the rotor teeth and stator teeth transversely to their longitudinal axes. The method provides a solution that is not bound to a specific geometry and other structural designs of the rotor teeth and stator teeth.

According to the invention, the method includes the following steps:
I. Definition of a value table in the data memory which comprises several table points, the table points being formed as value tuples. Each of the value tuples contains a pair of values from a setpoint torque and a rotor angle as well as an assigned setpoint current.
II. Performance of a partial cycle
II.1 Specification of a setpoint torque
II.2 Detection of a first actual rotor angle by the rotor angle sensor
II.3 By the control and evaluation unit, read-out of the setpoint current which is assigned to the first pair of values from the setpoint torque and the first actual rotor angle. Here, the two table points closest to the specified setpoint torque and the two table points closest to the actual rotor angle are determined and the distance of the real values of the setpoint torque and the first actual rotor angle to the table points is calculated. The setpoint current is determined by bilinear interpolation from the respective setpoint currents of the four table points.
II.4 Setting of the setpoint current by the current regulator
II.5 Application of current to the motor coils
II.6 Evaluation of the actual torque by the torque evaluator
II.7 Determination of a torque deviation by the control and evaluation unit by comparing the setpoint torque and the actual torque
II.8 Calculation of a corrected setpoint current by the control and evaluation unit on the basis of the torque deviation. The calculation is done for all four table points most recently used as a function of the interpolation distance used.
II.9 Entry of the calculated values of the corrected setpoint current in the four relevant value tuples of the value table by the control and evaluation unit and deletion of the previous values of the setpoint current
III. Repeated performance of the partial cycle until a rotor angle corresponding to a complete motor state is reached, thus forming a complete cycle
IV. Repeated performance of a complete cycle.

In the following, the method is described in detail with reference to the procedural steps:

### I. Definition of a Value Table

An example of a corresponding value table is shown in Table 1.

Setpoint currents are assigned to each a rotor angle (Θ_{(actual)}) and the setpoint torque for the respective motor coil to be energized. A table point forms a value tuple which comprises the rotor angle (Θᵢₛₜ), the setpoint torque (M_{Soll (setpoint)}) and at least one setpoint current, or preferably two setpoint currents, in particular one setpoint current for each of the two adjacent motor coils (I₁, I₂).

Table 1 shows a value table for a BLDC motor with two stator coils. For a BLDC motor with more coils, the value tuples contain additional setpoint current values for each additional coil.

This value table is stored in the data memory. The control and evaluation unit is configured to access the data memory and the value table.

### II. Performance of a Partial Cycle

### II.1 Specification of a Setpoint Torque

The specification of a setpoint torque is determined by the load to be provided by the motor. The setpoint torque is specified by the control and evaluation unit during the starting process of the switched BLDC motor.

### II.2 Detection of a First Actual Rotor Angle by the Rotor Angle Sensor

The rotor angle sensor measures the mechanical angular position of the rotor. In this way, it is known how the rotor teeth and the stator teeth are positioned relative to each other. Thus, the rotor angle sensor also determines the position of the rotor within a motor state.

### II.3 Read-Out of the Setpoint Current by the Control and Evaluation Unit

The control and evaluation unit reads out the setpoint currents to the closest rotor angles and the setpoint torque from the value table of the data memory.

The values of the four nearby table points which have been read out are set off against the real values, and the distance of the real values of the setpoint torque and the first actual rotor angle to the table points is determined. An example of four determined points is highlighted by a frame in the value table.

Bilinear interpolation is used to calculate the setpoint currents from the respective setpoint currents of the four table points.

### II.4 Setting of the Setpoint Currents by the Current Regulator

The current regulator sets the calculated setpoint currents for the respective motor coils. It can be any type of current regulator known from prior art which has sufficiently fast switching times. Preferably, it is a digital current regulator.

### II.5 Application of Current to the Motor Coils

The current regulator leads the setpoint current to the corresponding motor coil so that a magnetic flux is generated and consequently a force is applied to the rotor.

### II.6 Evaluation of the Actual Torque by the Torque Evaluator

The torque evaluator evaluates the actual torque. Preferably, the actual torque is determined from the available parameters such as the actual currents and the rotor angle.

### II.7 Determination of a Torque Deviation by the Control and Evaluation Unit

The control and evaluation unit determines a torque deviation by comparing the setpoint torque with the actual torque.

### II.8 Calculation of a Corrected Setpoint Current by the Control and Evaluation Unit on the Basis of the Torque Deviation

A detected torque deviation results in the finding that the level of the setpoint current was not completely suitable for setting the specified setpoint torque. Simultaneously, the size of the detected torque deviation provides a statement as to the extent to which a changed setpoint current would probably cause the actual torque corresponding to the setpoint torque.

According to the invention, the calculation is carried out for all four table points most recently used. The calculation is carried out as a function of the interpolation distance (h, I) used and the torque deviation (Mₛₒₗₗ-Mᵢₛₜ). Furthermore, a learning constant (K_{Lern (Learn)}) is included in the calculation.

### II.9 Entry of the Calculated Values of the Corrected Setpoint Current in the Four Relevant Value Tuples of the Value Table by the Control and Evaluation Unit and Deletion of the Previous Values of the Setpoint Current

The control and evaluation unit writes the values determined for the corrected setpoint currents in the value tuples of the four table points.

### III. Repeated Performance of the Partial Cycle Until a Motor Angle Corresponding to a Complete Motor State is Reached

The operating phase of the BLDC motor from one commutation to the next commutation is referred to as a motor state. In this process, the rotor runs through all angular positions, starting from the angular position of one commutation to the next commutation. The angular position of the rotor at the end of a motor state equals the angular position at the start of the next motor state.

The partial cycle is repeated until the rotor of the BLDC motor has reached a rotation angle that corresponds to a congruent position to the rotation angle at the start of the next motor state. Depending on the number of arms of the rotor, it always reaches a congruent position for such a motor state after an angle that corresponds to 360° divided by the number of motor states. Here, the rotor is assumed to be a rotational-symmetric one.

If a rotor arm corresponds to another rotor arm in terms of strength and orientation of its permanent-magnetic field, these rotor arms are referred to as being equivalent.

For example, in a three-arm rotor (with three equivalent arms), a first motor state is terminated every 120°. After running through three motor states, one complete rotation of the rotor is achieved. Thus, a complete cycle is the sum of all partial cycles performed from the start of a motor state to the termination of a motor state.

After reaching the first motor state, the partial cycle is performed for the next motor state and repeated until a complete cycle is reached again.

### IV. Repeated Performance of a Complete Cycle

The procedure is repeated for all subsequent complete cycles.

For a complete rotation of the rotor by 360°, three motor states and thus three complete cycles are performed for a three-arm rotor. For each motor state, a partial cycle is performed again and again until a complete cycle is reached again.

In the example according to Table 1, a first motor state is completed after a rotation of the rotor by 60°. For a complete rotor rotation of 360°, six motor states are run through.

This is repeated continuously to achieve a permanent rotation of the rotor.

The method according to the invention offers in particular the following special advantages.

The method is iteratively self-learning. With each run of a partial cycle, the table points are optimized in relation to the value of the setpoint current. With continued execution of the method, all table points are covered by the optimization. By means of repeated execution, the setpoint current more and more approximates to the optimum value so that the torque deviation is asymptotically set to zero.

Due to the continuously improving torque setting, a particularly effective vibration reduction is achieved as an advantage. The vibration reduction results in a particularly smooth running and noise reduction. In addition, the dynamic loads are reduced both for the motor itself and for the driven components and supporting structures of the motor.

Furthermore, it is advantageous that the method can be used for different motors without requiring adjustment or with only little adjustment effort. It is only necessary to initially set the value table with roughly determined values, which only have to enable the motor to run. When applying the method, each run of the partial cycles and the complete cycle leads to an automatic optimization of the values of the setpoint current in adjustment to the respective motor.

It is also advantageous that the method automatically compensates for any manufacturing tolerances.

Another advantage is given by the fact that the method provides automatic adjustment to changes that may only occur successively in the course of operation of the motor, such as imbalances or irregular running due to the wear of the bearings. The method has the effect that the setpoint currents are adjusted to the respective physical condition of the motor.

According to an advantageous further development, the value table is designed for a complete rotor rotation.

If the value table is designed for a complete rotor rotation, i.e., for a rotation of 360°, table points are assigned to each physical positional relation of a rotor tooth to a stator tooth in a reversibly clear manner. In this way, the method can compensate for even the finest manufacturing differences in the individual rotor or stator teeth, imbalances or signs of wear of the rotor. As a result, the running smoothness of the BLDC motor can be additionally increased and guaranteed even after long running times.

The invention is explained in more detail by way of example with reference to

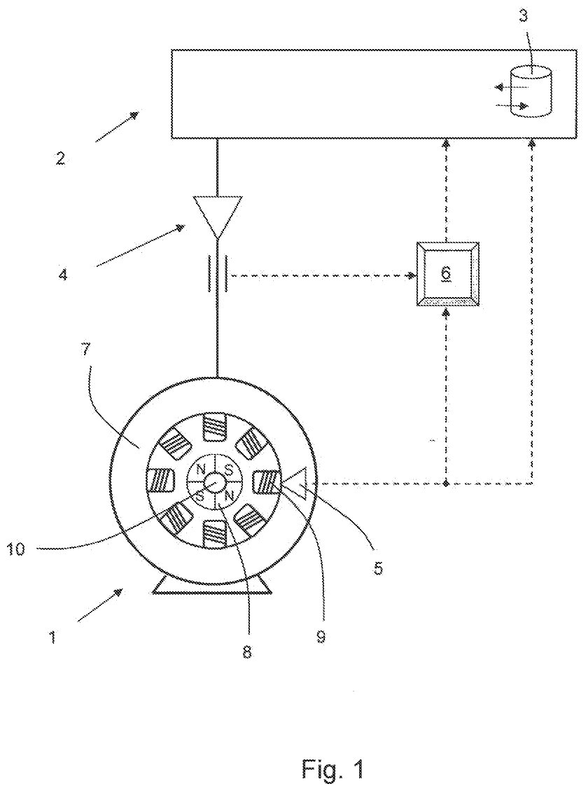

FIG. 1 BLDC motor assembly

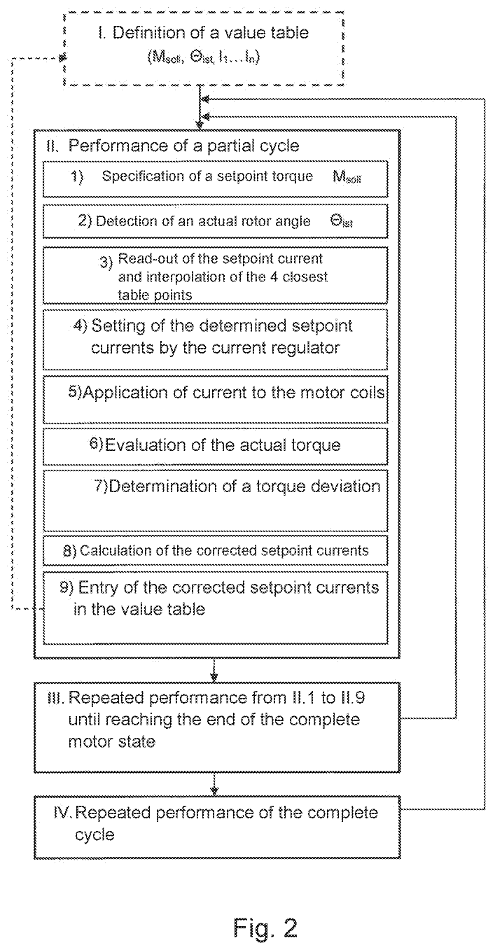

FIG. 2 Schematic flow chart of the method

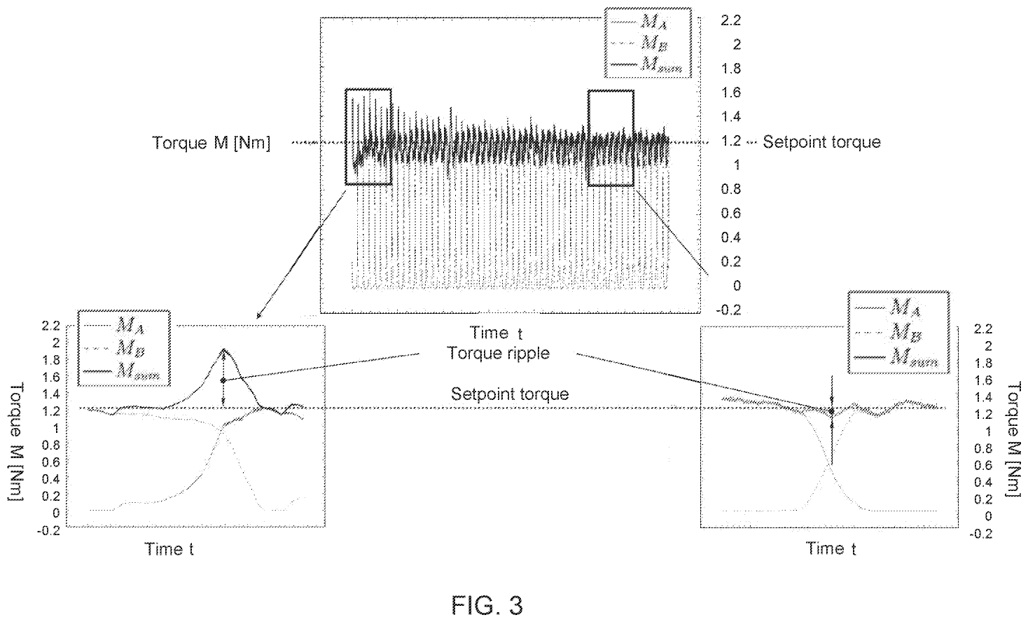

FIG. 3 Torque behaviour of the BLDC motor during the application of the method

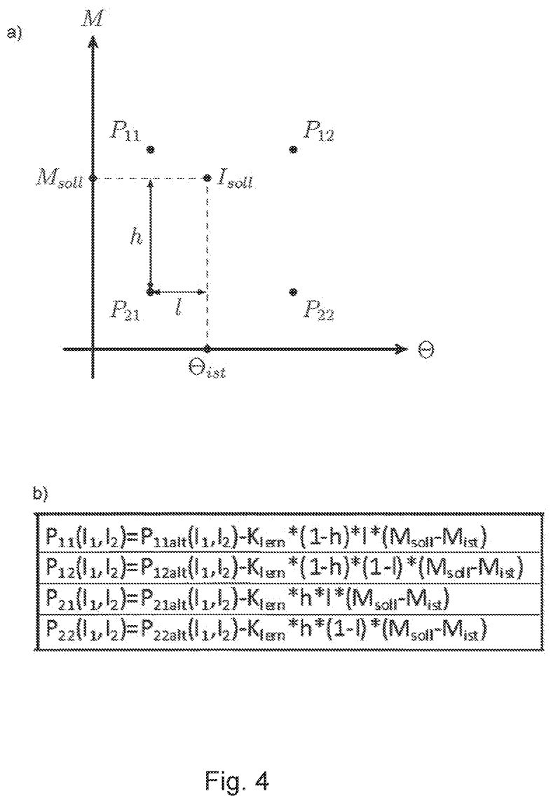

FIG. 4 Values, interpolation and calculation of the corrections.

FIG. 1 shows a schematic structure of the BLDC motor assembly.

The BLDC motor assembly comprises a control and evaluation unit 2, a data memory 3, a current regulator 4, a rotor angle sensor 5, a torque evaluator 6 and a BLDC motor 1.

The current regulator 4, the rotor angle sensor 5 and the torque evaluator 6 are each connected to the BLDC motor 1 and the control and evaluation unit 2.

In this embodiment, the data memory 3 with the value table is integrated into the control and evaluation unit 2.

The BLDC motor 1 has a stator 7, a rotor 8 and several motor coils 9.

In this embodiment, the rotor is designed as a cylinder with four permanent-magnetic poles. It is pivoted around the rotation axis 10.

The current regulator regulates the target currents for the stator coils 9 to the values transmitted by the control and evaluation unit 2.

The rotor angle sensor 5 determines the position of the rotor 8 and transmits it to the control and evaluation unit 2 and to the torque evaluator 6.

The torque evaluator 6 evaluates the actual torque from the parameters applied to the BLDC motor 1, in the example in particular from the actual current, in relation to a specific rotor angle, and also transmits said actual torque to the control and evaluation unit 2. From this, the control and evaluation unit 2 calculates a torque ii deviation and, on this basis, optimized setpoint current values and enters them into the value table of the data memory 3 deleting the previous setpoint current values.

FIG. 2 shows a schema of the method for a vibration-reduced operation of a switched BLDC motor. The schema gives a summary of all the procedural steps from I. to IV., wherein the procedural step II. is represented with all its sub-steps. The partial cycle (procedural step II.) is repeated until the end of the first motor state is reached, and upon reaching the first motor state, it is repeated until the end of the next motor state is reached (procedural step III.). This is a complete cycle.

The complete cycle is repeated for all motor states until a complete 360° rotation of the rotor is achieved (procedural step IV.). Once a complete rotation of the rotor has been terminated, the entire sequence can be repeated as often as required to effect a continuous rotation.

The value table is continuously updated in step II.9.

FIG. 3 shows a compilation of graphs to the torque behaviour of the BLDC motor during the application of the method. At the beginning (t=0 or on the left), the switched BLDC motor still shows high torque peaks, also referred to as torque ripples, which are caused by a suboptimal superposition of the partial torques, especially during the transition from one motor state to the next (at the bottom left). After several complete cycles, the torque peaks are significantly reduced (at the bottom right) and the partial torques overlap more advantageously. The torque peaks are responsible for a vibration of the rotor teeth and stator teeth and thus for the loud running noise of the BLDC motor. Hence, the reduction of the torque peaks also reduces the motor noise.

FIG. 4 shows the interpolation of the values in the coordinate system a) and the calculation of the corrections for the setpoint currents in table b).

The value interpolation according to procedural step II.3 is represented graphically in the coordinate system a). The control and evaluation unit is given the setpoint torque and the rotor angle sensor provides the actual rotor angle (Θᵢₛₜ). The control and evaluation unit determines the four closest table points (P11, P12, P21, P22) and interpolates a setpoint current (Iₛₒₗₗ) by bilinear interpolation. The value for a setpoint current (Iₛₒₗₗ) obtained in this way by interpolation is set by the current regulator in procedural steps II.4 and II.5 and transmitted to the motor coils.

In procedural step II.6, the torque evaluator evaluates the actual torque (Mᵢₛₜ) applied and, in procedural step II.7, the control and evaluation unit sets it off against the setpoint torque (Mₛₒₗₗ) to obtain a torque deviation (Mₛₒₗₗ-Mᵢₛₜ).

FIG. 4 shows in Table b) the calculation formulas for the correction values (according to procedural step II.8) with the torque deviation on the basis of the interpolation distances (h, I) used, a learning constant (K_{Lern}) and the torque deviation (Mₛₒₗₗ-Mᵢₛₜ).

### LIST OF REFERENCE NUMERALS

1 BLDC motor

2 control and evaluation unit

3 data memory

4 current regulator

5 rotor angle sensor

6 torque evaluator

7 stator

8 rotor

9 stator coils

10 rotation axis

1-2. (canceled)

3. A method for the optimized operation of a BLDC motor with a BLDC motor assembly, the method comprising:
providing the BLDC motor including a stator with stator coils, and a rotor with exciter magnets, the motor configured for applying a current to each of the stator coils;
providing the BLDC motor assembly with a control and evaluation unit, a data memory, a current regulator, a rotor angle sensor and a torque evaluator,
including the following procedural steps:
providing definition of a value table in the data memory including table points defined by value tuples each including a pair of values from a setpoint torque, a rotor angle and an assigned setpoint current;
II. performing a partial cycle, including the following sub-steps:
II.1 providing specification of the setpoint torque;
II.2 detecting a first actual rotor angle with the rotor angle sensor;
II.3 with the control and evaluation unit, reading-out the setpoint current assigned to the pair of values from the setpoint torque and the first actual rotor angle, by determining the closest table points and calculating the distance of real values of the setpoint torque and of the first actual rotor angle to the table points, determining a setpoint current by bilinear interpolation from the respective setpoint currents of four table points;
II.4 setting the setpoint current with the current regulator;
II.5 applying current to the stator coils;
II.6 evaluating the actual torque with the torque evaluator;
II.7 comparing the setpoint torque and the actual torque with the control and evaluation unit for determining a torque deviation;
II.8 calculating a corrected setpoint current with the control and evaluation unit, on the basis of the torque deviation, for all four table points most recently used as a function of interpolation distance used;
II.9 entering the calculated values of the corrected setpoint current in four relevant value tuples of the value table with the control and evaluation unit and deleting previous values of the setpoint current;
III. repeating performance of the partial cycle until a rotor angle corresponding to a complete motor state is reached for forming a complete cycle;
IV. repeating performance of a complete cycle.

4. The method for the vibration-reduced operation of a switched BLDC motor according to claim 3, wherein the value table is configured for a complete rotor rotation.
